(19) United States
(12) Patent Application Publication
(10) Pub. No.: US 2024/0083268 A1
(43) Pub. Date: Mar. 14, 2024

(54) ELECTRIC CHARGING SYSTEM FOR MARINE VESSELS

(71) Applicant: Sze Min George LEE, Singapore (SG)

(72) Inventor: Sze Min George LEE, Singapore (SG)

(21) Appl. No.: 18/273,356

(22) PCT Filed: Dec. 16, 2021
(86) PCT No.: PCT/SG2021/050792

§ 371 Date: Jul. 20, 2023

(30) Foreign Application Priority Data
Jan. 20, 2021 (SG) 10202100617W

(51) Int. Cl. B60L 53/126; B60L 53/34; B60L 58/13

(52) U.S. Cl. CPC B60L 53/126; B60L 53/34; B60L 58/13; B60L 2200/32

(57) ABSTRACT

An electric charging system for marine vessels, the system comprising: a charger configured to provide direct current (DC) power; a source fixed pad in electric communication with the charger via an inverter configured to convert DC power to high frequency alternating current (AC) power, the charger, the inverter and the source fixed pad provided on a fixed structure; a charging connector comprising a first connector pad, a second connector pad, and a flexible connector cable electrically connecting the first connector pad with the second connector pad, first and second vessel fixed pads provided on a marine vessel and each in electric communication with a vessel charging controller of the marine vessel, the vessel charging controller in electric communication with a battery system of the marine vessel and configured to convert AC power to DC power and DC power to AC power; wherein the source fixed pad, the first and second connector pads, and the first and second vessel fixed pads each comprise an induction coil encapsulated in a casing; wherein in use, the first connector pad forms a first charging connection with the source fixed pad for inductive power transmission from the source fixed pad to the first connector pad, the second connector pad forms a second charging connection with the first vessel fixed pad for inductive power transmission from the second connector pad to the first vessel fixed pad, thereby allowing power from the charger to be transmitted to the marine vessel via the charging connector, wherein AC power received by the marine vessel is converted to DC power by the vessel charging controller to charge the battery system of the marine vessel.

### TECHNICAL FIELD

This invention relates to an electric charging system for marine vessels.

### BACKGROUND

The following discussion of the background to the invention is intended to facilitate an understanding of the present invention only. It should be appreciated that the discussion is not an acknowledgement or admission that any of the material referred to was published, known or part of the common general knowledge of the person skilled in the art in any jurisdiction as at the priority date of the invention.

In the present application, the terms “marine vessels”, “electric marine vessels”, “electric vessels”, and “vessels” are used interchangeably to refer to fully electric marine vessels, plug-in hybrid marine vessels, marine vessels with energy storage and plug-in charging function, and the like.

Currently, charging of electric marine vessels allows only one vessel to be charged directly from an onshore charging station (shore-to-ship) at any point in time, i.e., in a one-station-to-one-vessel model. This requires a very large cable to be manually carried and physically plugged into a socket of the shore charging station and into a socket in the electric vessel to achieve charging via direct electrical contact. Thus, existing shore-to-ship charging is generally space-inefficient, high-cost, and for non-automatic systems, also needs human involvement when shifting the charging equipment from charging one vessel to another. The drawbacks of existing charging systems are that they are labour-intensive, experience mechanical wear-off, require human labour for connection, and present potential electric shock hazards.

### SUMMARY

This application discloses a low cost, unattended electric charging system that can be applied for shore-to-ship power transfer as well as thereafter for subsequent multiple ship-to-ship charging. This enables simultaneous electric charging of multiple marine vessels to take place. The electric charging system is a lightweight and low-cost interface for inductive power transfer between (1) an onshore charging station and at least one marine vessel or (2) power transfer between two marine vessels. Therefore, multiple vessels can be charged at the same time by connecting to each other via the electric charging system, without increasing the number of onshore charging stations.

According to a first aspect, there is provided an electric charging system for marine vessels, the system comprising: a charger configured to provide direct current (DC) power; at least one source fixed pad in electric communication with the charger via an inverter configured to convert the DC power to high frequency alternating current (AC) power, wherein the charger, the inverter and the source fixed pad are provided on a fixed structure; a first charging connector comprising a first connector pad, a second connector pad, and a flexible connector cable electrically connecting the first connector pad with the second connector pad, and a first vessel fixed pad and a second vessel fixed pad provided on a first marine vessel wherein the first vessel fixed pad and the second vessel fixed pad are each in electric communication with a vessel charging controller of the first marine vessel, wherein the vessel charging controller is in electric communication with a battery system of the first marine vessel, and wherein the vessel charging controller is configured to convert AC power to DC power and to convert DC power to AC power; wherein the source fixed pad, the first and second connector pads, and the first and second vessel fixed pads each comprise an induction coil encapsulated in a casing; wherein in use, the first connector pad is placed in physical contact with the source fixed pad to form a first charging connection for inductive power transmission from the source fixed pad to the first connector pad, and the second connector pad is placed in physical contact with the first vessel fixed pad of the first marine vessel to form a second charging connection for inductive power transmission from the second connector pad to the first vessel fixed pad of the first marine vessel, thereby allowing grid AC power from the charger to be transmitted to the first marine vessel via the first connector cable, wherein the AC power received by the first marine vessel is converted to DC power by the vessel charging controller of the first marine vessel to charge the battery system of the first marine vessel.

The electric charging system may further comprise a second charging connector, the second charging connector comprising a first connector pad, a second connector pad, and a connector cable electrically connecting the first connector pad with the second connector pad; wherein in use, the first connector pad of the second charging connector is placed in physical contact with the second vessel fixed pad of the first marine vessel, and the second connector pad of the second charging connector is placed in physical contact with a first vessel fixed pad of a second marine vessel, the first vessel fixed pad and a second vessel fixed pad of the second marine vessel are in electric communication with a vessel charging controller of the second marine vessel, and wherein the vessel charging controller of the second marine vessel is in electric communication with a battery system of the second marine vessel, and AC power from the first marine vessel is transmitted via the second charging connector to the second marine vessel and converted to DC power by the vessel charging controller of the second marine vessel to charge the battery system of the second marine vessel.

The AC power from the first marine vessel may be one of: AC power received by the first marine vessel from the charger, and AC power obtained by converting DC power from the battery system of the first marine vessel.

The vessel charging controller of each of the first and second marine vessels may be configured to enable direct electrical communication between the first vessel fixed pad and the second vessel fixed pad of each of the first and second marine vessels to allow AC power to pass through the vessel charging controller of each of the first and second marine vessels without conversion from AC to DC.

Each charging connection may comprise a self-aligning configuration to automatically align the induction coils in each charging connection for power transmission to occur.

The self-aligning configuration may comprise the first and second connector pads of each charging connector each comprising a peripheral skirt that projects downwardly from a bottom edge of each of the first and second connector pads, wherein the peripheral skirt is configured to fit over the source fixed pad and over each of the first and second vessel fixed pads of each marine vessel.

The source fixed pad and the first and second vessel fixed pads of each marine vessel may each comprise a radiused upper edge to facilitate ready placement of each of the first and second connector pads thereover.

According to a second aspect, there is provided a charging connector for an electric charging system for marine vessels, the charging connector comprising: a first connector pad; a second connector pad; and a flexible connector cable electrically connecting the first connector pad with the second connector pad; wherein the first and second connector pads and the first and second fixed pads each comprise an induction coil encapsulated in a casing; wherein in use, the first connector pad is placed in physical contact with a first fixed pad for inductive power transmission from the first fixed pad to the first connector pad, and the second connector pad is placed in physical contact with a second fixed pad for inductive power transmission from the second connector pad to the second fixed pad.

The first fixed pad may comprise one of: a source fixed pad in electric communication with a charger via an inverter, the charger configured to provide direct current (DC power) and the inverter configured to convert the DC power to high frequency AC power, and a transmitter vessel fixed pad provided on a first marine vessel in electric communication with a vessel charging controller of the first marine vessel, the vessel charging controller in electric communication with a battery system of the first marine vessel, the vessel charging controller configured to convert AC power to DC power and to convert DC power to AC power.

The second fixed pad may comprise one of: a receiver vessel fixed pad provided on the first marine vessel and in electric communication with the vessel charging controller of the first marine vessel when the first fixed pad is the source fixed pad, and a receiver vessel fixed pad provided on a second marine vessel and in electric communication with a vessel charging controller of the second marine vessel when the first fixed pad is the transmitter fixed pad of the first marine vessel.

The first and second connector pads may each comprise a peripheral skirt that projects downwardly from a bottom edge of each of the first and second connector pads, wherein the peripheral skirt is configured to fit over each of the first and second fixed pads.

For both aspects, the charger may be configured to convert grid AC power to DC power.

### BRIEF DESCRIPTION OF DRAWINGS

In order that the invention may be fully understood and readily put into practical effect there shall now be described by way of non-limitative example only exemplary embodiments of the present invention, the description being with reference to the accompanying illustrative drawings, in which:

FIG. 1 is a schematic side view illustration of an exemplary embodiment of an electric charging system for electric marine vessels when in use.

FIG. 2 is a schematic top view illustration of exemplary embodiments of induction coils in the electric charging system.

FIG. 3 is a schematic side view illustration of a charging connection when the electric charging system is in use.

FIG. 4 is a cross-sectional side view illustration of a self-aligning charging connection.

FIG. 5 is a schematic top view illustration of the electric charging system when in use to charge multiple strings of electric marine vessels.

FIG. 6 is a schematic side view illustration of the electric charging system of FIG. 1 showing communication paths between adjacent vessels and a charging station.

FIG. 7 is an illustration of examples of parameters taken into account to control charging of vessels.

### DETAILED DESCRIPTION OF THE EMBODIMENTS

Throughout this document, unless otherwise indicated to the contrary, the terms “comprising”, “consisting of”, “having” and the like, are to be construed as non-exhaustive, or in other words, as meaning “including, but not limited to.”

Furthermore, throughout the specification, unless the context requires otherwise, the word “include” or variations such as “includes” or “including” will be understood to imply the inclusion of a stated integer or group of integers but not the exclusion of any other integer or group of integers.

Unless defined otherwise, all technical and scientific terms used herein have the same meaning as is commonly understood by a skilled person to which the subject matter herein belongs.

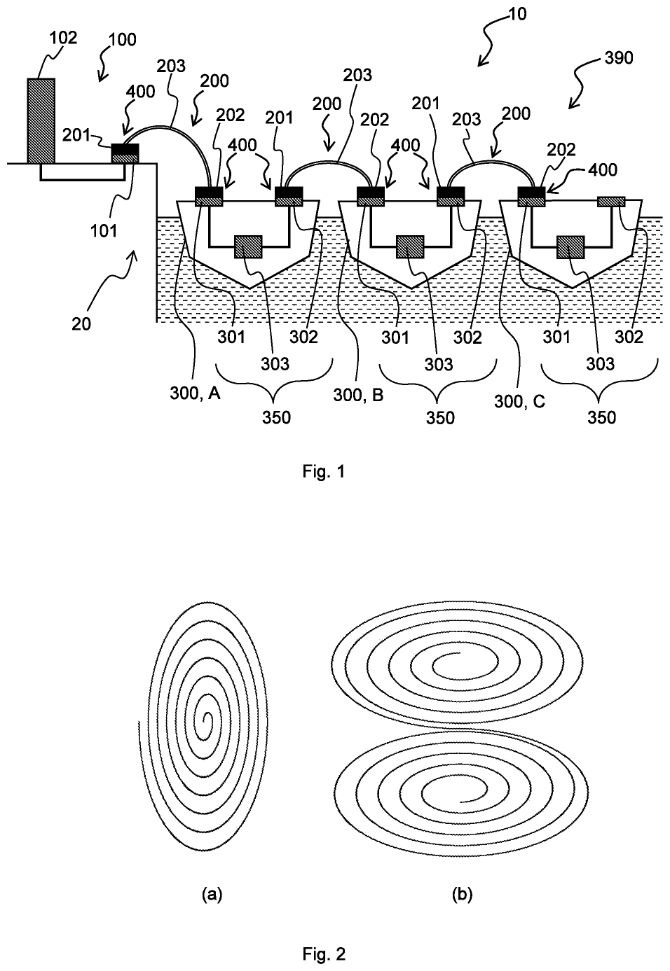

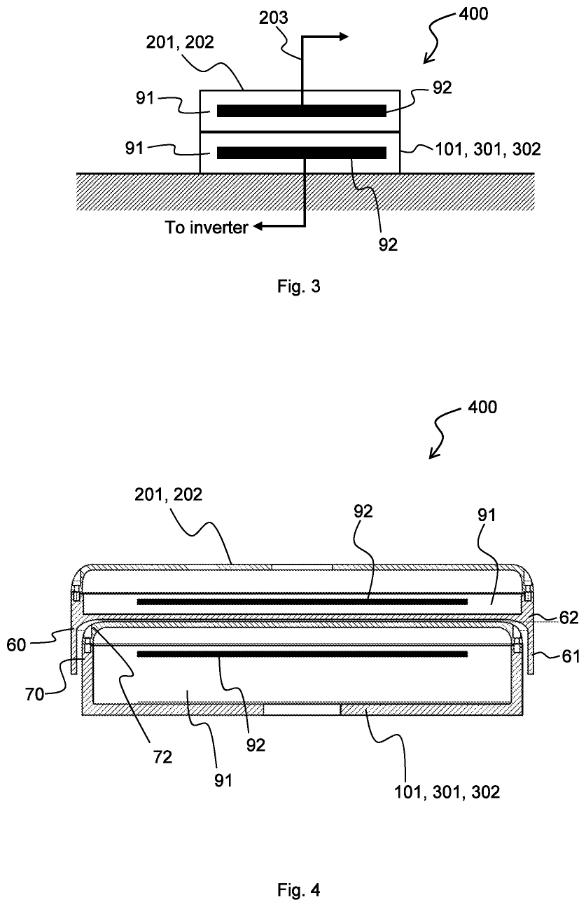

Exemplary embodiments of an electric charging system 10 for marine vessels 300 will be described below with reference to FIG. 1 to FIG. 7, wherein the same reference numerals are used to refer to the same or similar parts.

The electric charging system 10 is configured to allow for marine vessels 300 to be charged safely. In exemplary embodiments of use, the marine vessels 300 may be those below forty meters in length and operating around the coastal area. The electric charging system 100 is configured to allow multiple vessels 300 to be charged at the same time, as will be described in greater detail below.

As shown in FIG. 1, the electric charging system 10 comprises an onshore subsystem or charging station 100 provided on a fixed structure 20, at least one electric anchor or charging connector 200, and at least one electric vessel subsystem 350 provided on a vessel 300. The charging station 100 comprises at least one fixed anchor pad or source fixed pad 101 as shown in FIG. 2 that serves as a charging pad. The source fixed pad 101 is provided on a fixed structure 20 such as a quayside or a dolphin structure, for example, to which vessels 300 may be moored. In exemplary embodiments, the source fixed pad 101 is provided on a floor of the fixed structure 20. The source fixed pad 101 is electrically connected to a charger 102 provided in the charging station 100. The charger 102 is configured to provide direct current (DC) power. In some embodiments, this may be achieved by configuring the charger 102 to convert grid alternating current (AC) power into direct current (DC) power. For example, the charger 102 may comprise a conventional electric car DC charger 102 combined with a high frequency DC-AC converter.

Through a high frequency inverter (not shown) provided in the charging station 100, high frequency power is transmitted from the charger 102 to the source fixed pad 101. The charging station 100 may further comprise a power flow control subsystem or power management system (not shown), and a wireless communication subsystem (not shown). The power management system is configured to communicate with a battery management system (not shown) provided in each vessel 300 to manage the charging of the vessels 300. The power management system, the wireless communication subsystem, and the battery management system may be considered the software components of the electric charging system 10. The charging station 100 may also include an energy storage system (not shown) which may serve as a buffer of the grid power discharge to the charging station 100.

As shown in FIG. 1, each electric vessel subsystem 350 comprises at least two fixed anchors or vessel fixed pads 301, 302, and an electric anchor control or vessel charging controller 303 in electric communication with each of the vessel fixed pads 301, 302. The vessel charging controller 303 is configured to control charging of the vessel 300 via the vessel fixed pads 301, 302. The vessel fixed pads 301, 302 are active components that are driven or controlled by high frequency converters (not shown) provide in the vessel charging controller 303. Each vessel fixed pad 301, 302 may be a transmitter or a receiver of power, as will be described in greater detail below. The vessel fixed pads 301, 302 may be identical and are each provided on a port and a starboard side of the vessel 300, as can be seen in FIG. 1. In exemplary embodiments, the vessel fixed pads 301, 302 are provided on a deck of the vessel 300.

The vessel charging controller 303 is in electric communication with a battery system (not shown) on board the vessel 300, for example via a mini DC bus or a main DC micro grid, depending on a preferred mode of vessel power management control. Batteries in the battery system may be lithium-ion based, for example, although other appropriate types of batteries may also be used. Depending on the endurance of the electric mode required, energy storage capacity of the battery system will vary. The battery system is controlled by the battery management system which communicates with the power management system of the electric charging system 10, thereby controlling charging capacity during each charging operation.

The charging connector 200 comprises a first charging pad or first connector pad 201, a second charging pad or second connector pad 202, and a flexible connector cable 203 that electrically connects the first connector pad 201 with the second connector pad 202, as can be seen in FIG. 1. The cable 203 may be of any appropriate material or size and is configured to carry high frequency AC to enable electricity of various voltages and amperes to pass from the first connector pad 201 to the second connector pad 202 and vice versa, the first and second connector pads 201, 202 preferably being identical. Although the charging connector 200 is configured to serve as a conduit for power transfer, the charging connector 200 is not driven or controlled by any high frequency converters and comprises only passive elements, for example copper coils, capacitors, and optionally a light weight handle. The charging connector 200 is designed to be light in weight and to be a loose item that may be stored on the vessel 300, preferably on deck, when not in use. It 200 is configured to withstand rough handling and built to be easily replaced due to damage or loss (e.g. dropped into water). In this way, the charging connector 200 can be produced at low cost. To avoid accidental loss, the charging connector 200 may be attached to the vessel 300 with a safety cord (not shown) to prevent it from falling into the water. In addition to the connector cable 203, the charging connector 200 may further comprise a safety rope (not shown) connecting the two connector pads 201. The safety rope is shorter than the connector cable 203 to prevent the connector cable 203 from being pulled taut when in use. In exemplary embodiments, the connector cable 203 may have a length ranging from 1.5 metres to 2 metres or more.

The source fixed pad 101, the vessel fixed pads 301, 302, and the connector pads 201, 202 may each comprise a casing 91 housing or encapsulating an induction coil 92 therein. The source fixed pad 101 and the vessel fixed pads 301, 302 may be identical or similar. Each pad 101, 201, 202, 301, 302 may have a length ranging from 350 mm to 500 mm, a width ranging from 350 mm to 500 mm, and a thickness ranging from 150 mm to 200 mm, for example. A material for the casing 91 may be polymer-based and configured to withstand harsh marine environments, so as to be resistant to damage under UV irradiation, contact with salt water or mechanical impact from having equipment and other things dropped on it. The induction coil 92 may have a single coil configuration as shown in FIG. 2(a), or a dual ear loop configuration as shown in FIG. 2(b) that may provide better power transfer efficiency.

In use, the electric charging system 100 uses induction wireless charging or inductive power transmission as a means to transfer power between two pads that are placed in direct physical contact with each other to form a charging anchor point (CAP) or charging connection 400, as shown in FIGS. 1, 3 and 4, such that there is no air gap between the two pads of the charging connection 400, and also no wired electrical connection between the two pads of the charging connection 400. Each charging connection 400 comprises two pads, wherein the first pad is a fixed pad 101, 301, 302 provided on the fixed structure 20 or a vessel 300, and the second pad is one of the connector pads 201, 202 of the charging connector 200. Thus, for each charging connection 400, there are two induction coils 92 placed in close proximity with each other. Distance between the inductions coils 92 in each of the two pads of the charging connection 400 may comprise two times a thickness of the material of the casing 91 surrounding each induction coil 92.

Each connector pad 201, 202 may be considered a loose anchor or loose pad as it is configured to be removably attachable to a fixed pad 101, 301, 302. In contrast, the fixed pads 101, 301, 302 are not configured to be removable from the locations at which they are provided. In an exemplary embodiment, all the fixed pads 101, 301, 302 are upward facing while each connector pad 201, 202 is downward facing on a fixed pad 101, 301, 302 when each charging connection 400 is formed.

In an exemplary embodiment of use, the first connector pad 201 of a charging connector 200 is placed on top of and in direct physical contact with the source fixed pad 101, and the second connector pad 202 of the same charging connector 200 is placed on top of and in direct physical contact with a first vessel fixed pad 301. In this way, two charging connections 400 are formed: one at the charging station 100 and one at the vessel 300 being charged, with the two charging connections 400 being electrically connected via the flexible charging cable 203 of the charging connector 200. The charging connection 400 at the charging station 100 transfers power from the source fixed pad 201 to the first connector pad 201 while the charging connection 400 at the vessel 300 being charged transfers power from the second connector pad 202 to the first vessel fixed pad 301.

Preferably, the charging connection 400 is configured to be self-aligning such that when a downward facing connector pad 201, 202 is placed on an upward facing fixed pad 101, 301, 302, both their induction coils 92 will be automatically aligned in order to allow power transfer to take place. Preferably, the self-aligning configuration results in the connector pad 201, 202 either properly engaging the fixed pad 101, 301, 302 (i.e. to align both their induction coils 92) or not at all. The self-aligning configuration is preferably designed to constrain the charging connection 400 to stay aligned regardless of vessel motion as a result of wave action. In this way, no active heave compensation is required for induction coil alignment which is crucial for power transfer efficiency.

In an exemplary embodiment as shown in FIG. 4, the self-aligning configuration of the charging connection 400 may comprise interfacing surfaces 60, 70 of the connector pads 201, 202 and of the fixed pads 101, 301, 302 respectively being configured to minimize or prevent relative lateral movement therebetween once they 60, 70 engage each other to form the charging connection 400. For example, the interfacing surface 60 of the connector pads 201, 202 may comprise a peripheral skirt 61 that projects downwardly from a bottom edge 62 of each connector pad 201, 202. The skirt 61 is configured to fit over each fixed pad 101, 301, 302 such that the connector pad 201, 202 self-aligns and sits on the fixed pad 101, 301, 302 once put in place on the fixed pad 101, 301, 302 to form the charging connection 400. The skirt 61 is dimensioned to allow relative axial movement between each connector pad 201, 202 and a fixed pad 101, 301, 302 to allow each connector pad 201, 202 to be readily placed on and removed from a fixed pad 101, 301, 302 while minimizing or preventing relative lateral movement between the connector pad 201, 202 and the fixed pad 101, 301, 302 once the connector pad 201, 202 has been placed on the fixed pad 101, 301, 302 to form the charging connection 400. The interfacing surface 70 of the fixed pads 101, 301, 302 may comprise a radiused upper edge 72 that provides a rounded exposed edge to the fixed pad 101, 301, 302. The radiused upper edge 72 serves to guide and align placement of the connector pad 201, 202 onto the fixed pad 101, 301, 302 without requiring initial perfect axial alignment of the connector pad 201, 202 with the fixed pad 101, 301, 302 when forming the charging connection 400, while also reducing mechanical wear and tear on the skirt 61 of the connector pads 201, 202.

As the flexible connector cable 203 of the charging connector 200 exerts minimal force on the charging connection 400 even in the face of vessel movement, the charging connection 400 can therefore rely simply on gravity and the self-aligning configuration as described above to keep the two pads of the charging connection 400 in aligned contact with each other for uninterrupted, efficient power transfer from one pad to the other. This allows a high degree of freedom in the electric charging system 10 and mitigates the need for active alignment of the two pads of the charging connection 400 to avoid breaking the charging connection 400 as a result of wave action dislodging the connector pad 201, 202 from the fixed pad 101, 301, 302 after the charging connection 400 has been formed. By providing the fixed pad 101, 301, 302 in an upward facing direction and the connector pad 201, 202 in a downward facing direction in each charging connection 400, it can be observed that during charging, the fixed pad 101, 301, 302 and the connector pad 201, 202 are aligned in generally the same horizontal plane while allowing for vessel movement due to wave action.

In use, to complete a charging loop for one vessel 300, as can be seen in FIG. 1, one of the connector pads 201 of the charging connector 200 is placed on top of the source fixed pad 101 to form a first charging connection 400 and the other of the connector pads 202 is placed on top of one of the vessel fixed pads 301 on a vessel A adjacent the fixed structure 20 to form a second charging connection 400. This allows electrical charge from the charging station 100 to be transferred to the vessel A via the two charging connections 400 established by using the charging connector 200 to connect the source fixed pad 101 with the vessel fixed pad 301.

Charging multiple vessels 300 is achieved by using multiple charging connectors 200 to interconnect adjacent vessels 300 as shown in FIGS. 1, 5 and 6. In an exemplary embodiment as can be seen in FIG. 1, a first charging connector 200 is used to connect the source fixed pad 101 with a first vessel fixed pad 301 on a vessel A adjacent the fixed structure 20. A second charging connector 200 is then used to connect a second vessel fixed pad 302 on the vessel A with a first vessel fixed pad 301 on a vessel B adjacent the vessel A. A third charging connector 200 is used to connect a second vessel fixed pad 302 on the vessel B with a first vessel fixed pad 301 on a vessel C adjacent the vessel B. A string 390 of interconnected vessels 300 is thus formed.

For a vessel fixed pad 302 to act as a power sender or transmitter, high frequency AC power provided by the vessel charging controller 303 of the vessel 300 will activate the induction coil 92 of the vessel fixed pad 302 to induce another high frequency AC power on a first connector pad 201 of a charging connector 200 that is placed in contact with the vessel fixed pad 302. Likewise, high frequency AC power from the induction coil 92 in the second connector pad 202 of the same charging connector 200 will induce high frequency AC power in a vessel fixed pad 301 of another vessel B on which it is placed. In this way, the electric charging system 10 uses available wireless induction power transfer principle to “jump” or transfer power from between the fixed pads 101, 301, 302 through the loose pads 201, 202. As adjacent vessels 300 are able to transmit power to each other, this eliminates the need for each vessel 300 to be moored to the fixed structure 20 to obtain power directly from the charging station 100 on the fixed structure 20, thereby eliminating the problem of there not being enough berthing spots for vessels to be charged immediately alongside the fixed structure 20. By controlling the power flow, all the vessels 300 can be charged simultaneously in a balanced and safe manner.

While FIG. 1 depicts three vessels 300 being berthed and charged, the number of vessels 300 electrically connected to one source fixed pad 101 may be increased, for example to five or more vessels. Notably, the speed of charging is not being dictated by the number of vessels queuing up to be charged but by the optimum capacity for safe charging.

In some embodiments, where space is available, the charging station 100 may comprise multiple source fixed pads 101 provided at intervals along the fixed structure 20, as shown in FIG. 5. This not only allows for simultaneous charging of multiple vessels 300 immediately adjacent the fixed structure 20, it also allows for simultaneous charging of multiple strings 390 of vessels 300 wherein each string 390 of vessels 300 is connected to one or more source fixed pads 101 using multiple charging connectors 200 wherein each charging connector 20 connects a pair of adjacent vessels 300. In some embodiments, as shown in the first string 390-1 of vessels in FIG. 5, each vessel may be provided with more than one pair of vessel fixed pads 301, 302 to improve charging efficiency.

Using the above described electric charging system 10, one can connect multiple vessels 300 easily using the charging connectors 200 between adjacent vessels 300 without the assistance of any mechanical equipment. This makes the electric charging system 10 easy to use, and the electric charging system is also cost effective as each charging connector 200 is inexpensive.

In all embodiments, the charging connection 400 is preferably designed to establish a weak suction in the physical connection between the two pads of the charging connection 400. In this way, in the event of a violent or abrupt movement between adjacent vessels 300 or between a vessel 300 adjacent the fixed structure 20 and the fixed structure 20, the power jump or transfer is broken and the loose or connector pad 201, 202 easily disconnects from the fixed pad 101, 301, 302 to separate the two pads of the charging connection 400, so that no external power leakage occurs. Even though accidental separation of the two pads of a charging connection 400 results in an open charging circuit, this will not have any grave impact on the vessels 300 or give rise to any electrocution risk, thereby providing a safer charging situation.

As can be seen in FIG. 5, there is no requirement for the vessels 300 to be all oriented in the same direction as the vessel fixed pads 301, 302 of each vessel can each serve either as a transmitter or receiver of power. In some embodiments, this may be achieved by controlling the transmitting and receiving frequency in the kilohertz range, by using an Insulated-Gate Bipolar Transistor (IGBT) based inverter provided in the vessel charging controller 303 of each vessel. For example, the IGBC-based inverter in a first vessel may convert DC current to high frequency AC current when transmitting the power in the battery system of the first vessel to charge the battery system of a second vessel. In other embodiments, for example when transmitting AC power obtained from the charger 102 via a first vessel to charge the battery system of a second vessel, the vessel charging controller 303 of the first vessel may enable direct electrical communication between the first vessel fixed pad 301 acting as a receiver on the first vessel and the second vessel fixed pad 302 acting as a transmitter on the first vessel such that the AC power received by the first vessel fixed pad 301 is directly communicated as AC power to the second vessel fixed pad 302 (for onward transmission to the second vessel) without conversion to DC power by the vessel charging controller of the first vessel.

For all embodiments, a vessel fixed pad 301, 302 acting as a receiver on an adjacent second vessel being charged will receive power from a first vessel via a charging connector 200 that connects the transmitter vessel fixed pad 301, 302 on the first vessel with the receiver vessel fixed pad 301, 302 on the second vessel. As the power is received in high frequency AC current by the second vessel, an IGBT-based inverter provided in the vessel charging controller 303 of the second vessel will convert the AC current to DC current in order to charge the battery system of the second vessel. Thus, it can be said that the vessel charging controller 303 of each vessel is configured to convert AC power to DC power and to convert DC power to AC power (for the purposes of charging that vessel and for drawing power from the battery system of that vessel to charge another vessel), as well as to enable direct electrical communication between a first vessel fixed pad and a second vessel fixed pad of that vessel to allow AC power to pass through the vessel charging controller 303 of that vessel without conversion from AC to DC (for the purpose of charging another vessel). By configuring the vessel fixed pads 301, 302 of each vessel to be able to serve either as a transmitter or receiver of power, power transfer between vessels 300 can be bi-directional relative to each vessel, thereby allowing adjacent vessels 300 in a string of vessels 300 to be oriented in either the same or opposite directions when being charged using the electric charging system 10. For a vessel having a vessel fixed pad 301 directly connected to the source fixed pad 101 via a charging connector 200, the vessel fixed pad 301 accordingly functions as a receiver vessel fixed pad 301 that receives AC current from the source fixed pad 101.

To manage traffic in embodiments where multiple source fixed pads 101 are available on the fixed structure that allow for multiple strings of vessels 390 to berth alongside (such as that shown in FIG. 5), a system regulating the charging capacity of the charging station 100 may be used. For example, a visual indicator, e.g., a traffic light of green, amber, and red lights, may be installed at each source fixed pad 101. Green light may indicate that there is available charging capacity at that source fixed pad 101. Amber light may indicate that the charging capacity is almost used up or that the charging capacity is increasing due to some of the vessels being almost charged. Red light may indicate that the charging capacity is currently fully used or depleted and the system cannot regulate the charging to start charging an incoming vessel until a condition occurs that allows charging to start.

Notably, the vessel charging controller 330 of each vessel 300 communicates wirelessly with the charging station 100. This is achieved using currently available wireless communication technology, in order to coordinate the power requirements of each vessel 300. The communication protocol used in the wireless communication should thus be open source, stating clearly information such as the identity, power requirement and payment information of each vessel 300 to be charged using the electric charging system 10.

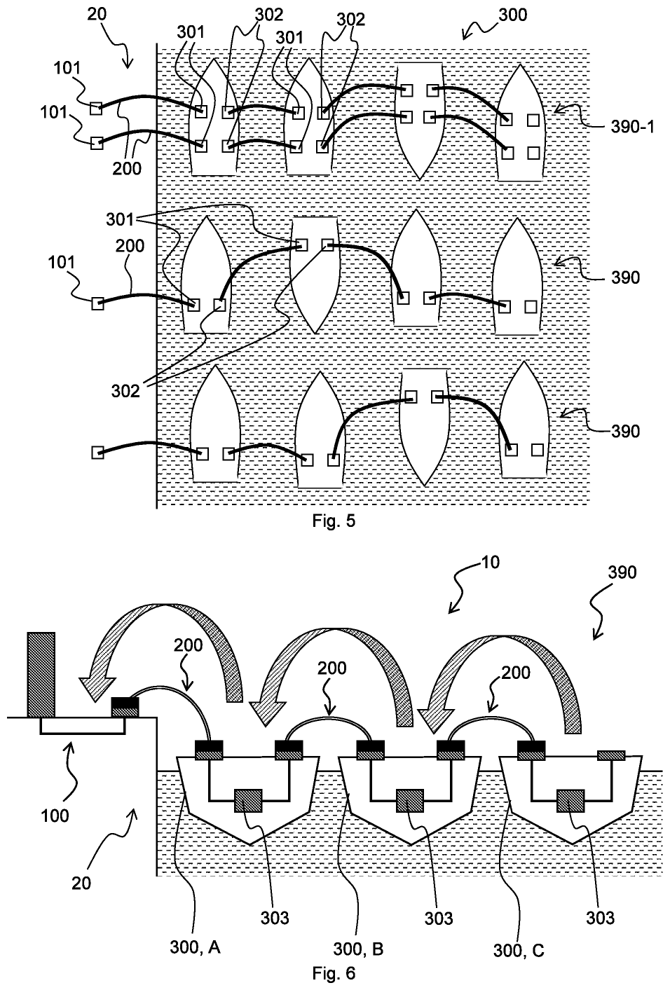

In an exemplary embodiment as shown in FIG. 6 (similar to FIG. 1), the wireless communication is configured to hop from one vessel 300C to the next vessel 300B towards the vessel 300A immediately adjacent the fixed structure 20, as indicated by the hatched arrows in FIG. 6. In this way, the vessel 300A closest to the fixed structure 20 will be the one communicating with the charging station 100. The vessel 300A closest to the fixed structure 20 takes the demand of all other berthing vessels 300B, 300C in the string 390 of vessels 300 and communicates them to the charging station 100. As such, the amount of information being wireless transmitted from the furthest vessel 300C towards the charging station 10 progressively increases with each hop towards the charging station 100. Response or output from the charging station 100 will also pass from the vessel 300A closest to the fixed structure 20 towards the furthest vessel 300C.

In exemplary embodiments, control of electric charging of the string 390 of vessels 300 is centralized at the power management system provided at the charging station 100. The power management system coordinates the rate of charging per vessel 300 depending on various parameters communicated from each vessel 300 to the charging station 100, such as the state of charge (SoC) and the size of the batteries on board each vessel 300. Preferably, planned departure time of each vessel 300 should also be included among the parameters so that allocation of charging capacity can be planned by the power management system.

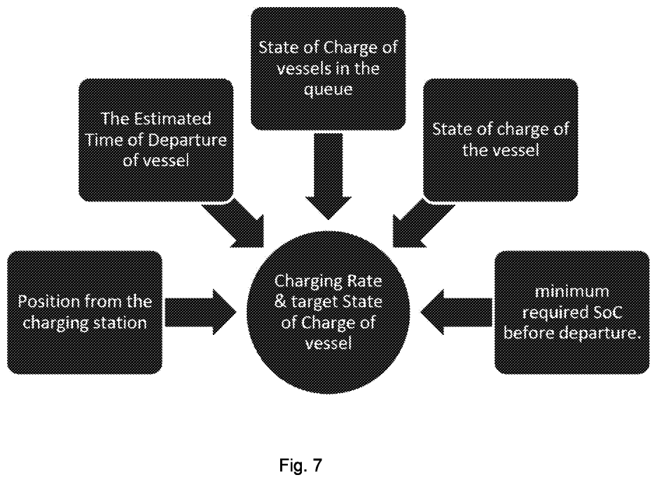

The power management system is configured to control charging of the vessels according to several major parameters, such as those shown in FIG. 7. The sequence and logic of charging the vessels may also depend on the following major parameters, for example:
Number of vessels between a newly connected vessel and the charging station
Estimated time before each vessel intends to depart
Current state of charge of each vessel
State of charge of vessels in the queue or string of vessels
Minimum required state of charge of each vessel before departure

Examples of the parameters taken into account by the power management system to control charging of each vessel 300 are shown in FIG. 7.

In an exemplary embodiment of use, when a vessel 300 newly arrives for charging, it will be placed in electric communication with the source fixed pad 101, whether directly or via other vessels 300 in between. The power management system then receives estimated time of departure of the newly arrived vessel 300, whether from the vessel operating system newly arrived vessel or its vessel operator. The power management system may then take into account the amount of time required to charge the newly arrived vessel, e.g., to the highest possible rate within the available time to departure, and may then inform the vessel operating system or the vessel operator accordingly.

When controlling charging, the power management system regulates the charging speed of each charging connection 400. For example, if a vessel that is most recently connected to a string of vessels that are already connected to the charging station 100 has a sooner departure time than the earlier connected vessels, the power management system is preferably configured to be able to direct charging power to that most recently connected vessel instead of the earlier connected vessels. In an exemplary embodiment, when power from the charging station 100 is directed to charge a vessel with other interconnected vessels between the charging station 100 and the vessel being charged, the charging power is transmitted as high frequency AC across all the vessels in between, and only converted to DC for storage at the vessel that is being charged.

In another example, if a second vessel from the fixed structure 20 is being charged, stored energy from the third and fourth vessels from the fixed structure 20 may be used to charge a fifth vessel connected to the fourth vessel. Thus, the sequence and charging of vessels in a string of vessels 390 connected to the charging station 100 may be varied according to one or more of the above-mentioned parameters that has been obtained from each of the connected vessels 300 to be charged.

In embodiments where there are a few shore charging stations along a quay side that allow for a few rows of vessel to berth alongside, a system regulating the charging capacity of the shore charging stations may be used. For example, a visual indicator, e.g. a traffic light of green, amber, and red lights, may be installed on the berth at each charging station. Green light may indicate that there is available charging capacity at the shore charging station. Amber light may indicate that the charging capacity is almost used up or that the charging capacity is increasing due to some of the vessels being almost charged. Red light may indicate that the charging capacity is currently fully used or depleted and the system cannot regulate the charging to start charging the incoming vessel until a condition that allows the charging to start happens.

The above described invention thus allows high power levels for charging the batteries of electric marine vessels that removes the need for plug-in electrical connection and also requires no additional berth space. It eliminates the risk of electric shocks and also significantly reduces the need for multiple onshore stations to meet the demands of charging multiple electric vessels at any one time.

While there has been described in the foregoing description exemplary embodiments of the present invention, it will be understood by those skilled in the technology concerned that many variations in details of design, construction and/or operation may be made without departing from the present invention.

1. An electric charging system for marine vessels, the system comprising:
a charger configured to provide direct current (DC) power;
at least one source fixed pad in electric communication with the charger via an inverter configured to convert the DC power to high frequency alternating current (AC) power, wherein the charger, the inverter and the source fixed pad are provided on a fixed structure;
a first charging connector comprising a first connector pad, a second connector pad, and a flexible connector cable electrically connecting the first connector pad with the second connector pad, and
a first vessel fixed pad and a second vessel fixed pad provided on a first marine vessel wherein the first vessel fixed pad and the second vessel fixed pad are each in electric communication with a vessel charging controller of the first marine vessel, wherein the vessel charging controller is in electric communication with a battery system of the first marine vessel, and wherein the vessel charging controller is configured to convert AC power to DC power and to convert DC power to AC power;
wherein the source fixed pad, the first and second connector pads, and the first and second vessel fixed pads each comprise an induction coil encapsulated in a casing;
wherein in use, the first connector pad is placed in physical contact with the source fixed pad to form a first charging connection for inductive power transmission from the source fixed pad to the first connector pad, and the second connector pad is placed in physical contact with the first vessel fixed pad of the first marine vessel to form a second charging connection for inductive power transmission from the second connector pad to the first vessel fixed pad of the first marine vessel, thereby allowing power from the charger to be transmitted to the first marine vessel via the first charging connector, wherein the AC power received by the first marine vessel is converted to DC power by the vessel charging controller of the first marine vessel to charge the battery system of the first marine vessel.

2. The electric charging system of claim 1, further comprising a second charging connector, the second charging connector comprising a first connector pad, a second connector pad, and a connector cable electrically connecting the first connector pad with the second connector pad; wherein in use,
the first connector pad of the second charging connector is placed in physical contact with the second vessel fixed pad of the first marine vessel, and the second connector pad of the second charging connector is placed in physical contact with a first vessel fixed pad of a second marine vessel,
the first vessel fixed pad and a second vessel fixed pad of the second marine vessel are in electric communication with a vessel charging controller of the second marine vessel, and wherein the vessel charging controller of the second marine vessel is in electric communication with a battery system of the second marine vessel, and
AC power from the first marine vessel is transmitted via the second charging connector to the second marine vessel and converted to DC power by the vessel charging controller of the second marine vessel to charge the battery system of the second marine vessel.

3. The electric charging system of claim 2, wherein the AC power from the first marine vessel is one of:
AC power received by the first marine vessel from the charger, and
AC power obtained by converting DC power from the battery system of the first marine vessel.

4. The electric charging system of claim 2, wherein the vessel charging controller of each of the first and second marine vessels is configured to enable direct electrical communication between the first vessel fixed pad and the second vessel fixed pad of each of the first and second marine vessels to allow AC power to pass through the vessel charging controller of each of the first and second marine vessels without conversion from AC to DC.

5. The electric charging system of claim 1, wherein the charger is configured to convert grid AC power to DC power.

6. The electric charging system of claim 1, wherein each charging connection comprises a self-aligning configuration to automatically align the induction coils in each charging connection for power transmission to occur.

7. The electric charging system of claim 6, wherein the self-aligning configuration comprises the first and second connector pads of each charging connector each comprising a peripheral skirt that projects downwardly from a bottom edge of each of the first and second connector pads, wherein the peripheral skirt is configured to fit over the source fixed pad and over each of the first and second vessel fixed pads of each marine vessel.

8. The electric charging system of claim 7, wherein the source fixed pad and the first and second vessel fixed pads of each marine vessel each comprise a radiused upper edge to facilitate ready placement of each of the first and second connector pads thereover.

9. A charging connector for an electric charging system for marine vessels, the charging connector comprising:
a first connector pad;
a second connector pad; and
a flexible connector cable electrically connecting the first connector pad with the second connector pad;
wherein the first and second connector pads and the first and second fixed pads each comprise an induction coil encapsulated in a casing;
wherein in use, the first connector pad is placed in physical contact with a first fixed pad for inductive power transmission from the first fixed pad to the first connector pad, and the second connector pad is placed in physical contact with a second fixed pad for inductive power transmission from the second connector pad to the second fixed pad.

10. The charging connector of claim 9, wherein the first fixed pad comprises one of:
a source fixed pad in electric communication with a charger via an inverter, the charger configured to provide direct current (DC power) and the inverter configured to convert the DC power to high frequency AC power, and
a transmitter vessel fixed pad provided on a first marine vessel in electric communication with a vessel charging controller of the first marine vessel, the vessel charging controller in electric communication with a battery system of the first marine vessel, the vessel charging controller configured to convert AC power to DC power and to convert DC power to AC power.

11. The charging connector of claim 9, wherein the second fixed pad comprises one of:
a receiver vessel fixed pad provided on the first marine vessel and in electric communication with the vessel charging controller of the first marine vessel when the first fixed pad is the source fixed pad, and
a receiver vessel fixed pad provided on a second marine vessel and in electric communication with a vessel charging controller of the second marine vessel when the first fixed pad is the transmitter fixed pad of the first marine vessel.

12. The charging connector of claim 9, wherein the charger is configured to convert grid AC power to DC power.

13. The charging connector of claim 9, wherein the first and second connector pads each comprises a peripheral skirt that projects downwardly from a bottom edge of each of the first and second connector pads, wherein the peripheral skirt is configured to fit over each of the first and second fixed pads.
